(19) United States
(12) Patent Application Publication
(10) Pub. No.: US 2022/0165507 A1
(43) Pub. Date: May 26, 2022

(54) CAPACITOR, PARTICULARLY AN INTERMEDIATE CIRCUIT CAPACITOR FOR A MULTIPHASE SYSTEM

(71) Applicant: Robert Bosch GmbH, Stuttgart (DE)

(72) Inventor: Martin Kessler, Schwaebisch Gmuend (DE)

(21) Appl. No.: 17/440,876

(22) PCT Filed: Feb. 12, 2020
(86) PCT No.: PCT/EP2020/053527

§ 371 Date: Sep. 20, 2021

(30) Foreign Application Priority Data
Mar. 21, 2019 (DE) 10 2019 203 843.3

(51) Int. Cl. H01G 4/32; H01G 4/38

(52) U.S. Cl. CPC H01G 4/32; H01G 4/38

(57) ABSTRACT

The invention relates to a capacitor (1), particularly an intermediate circuit capacitor for a multiphase system, having a plurality of identical capacitor elements (10), which are connected in parallel and together form the capacitor (1), wherein at least one intermediate space (20) is formed between the capacitor elements (10), at least one intermediate capacitor element (30) is arranged in the intermediate space (20) and is connected in parallel to the capacitor elements (10), and thus together with the capacitor elements (10) forms the capacitor (1).

### BACKGROUND OF THE INVENTION

The invention relates to a capacitor, particularly an intermediate circuit capacitor for a multi-phase system, having a plurality of capacitor elements of identical design, which are mutually connected in parallel and/or in series and, in combination, constitute the capacitor, wherein at least one interspace is constituted between the capacitor elements.

In power electronics, a plurality of electrical networks are energetically bonded to a common DC voltage level by means of electrical capacitors in an intermediate circuit of converters. As a result of the repeated execution of switching operations, high frequency-related power losses are associated with the alternating phase currents.

Intermediate circuit capacitors comprise a plurality of capacitor elements which are connected in parallel and which, in combination, constitute the intermediate circuit capacitor. In intermediate circuit capacitors for drive system inverters, foil capacitors in the form of “flat windings” are currently employed, as intermediate circuit capacitors based upon flat windings are significantly simpler and more cost-effective to produce than capacitors produced, for example, by stitching technology, in which cuboid capacitor elements are employed.

### SUMMARY OF THE INVENTION

According to the invention, a capacitor, particularly an intermediate circuit capacitor for a multi-phase system, is proposed. The capacitor comprises a plurality of capacitor elements of identical design. The capacitor elements of identical design are mutually connected in parallel and/or in series and, in combination, constitute the capacitor. At least one interspace is constituted between the capacitor elements. According to the invention, at least one intermediate capacitor element is arranged in the interspace, which is connected in parallel with the capacitor elements and thus, in combination with the capacitor elements, constitutes the capacitor.

The employment of flat windings as capacitor elements for intermediate circuit capacitors is associated with a disadvantage, in that available structural space for intermediate circuit capacitors is not optimally exploited, on the grounds that vacant interspaces are present between the individual flat windings in the intermediate circuit capacitor, dictated by the geometrical arrangement thereof. In comparison with the prior art, the capacitor according to the invention provides an advantage, in that available structural space for the capacitor can be optimally exploited and, with minimum structural space, a maximum capacitance density of the capacitor can be achieved. It is thus further permitted that, in the available structural space, loss resistance, and thus the losses generated, are minimized. Moreover, the maximum winding temperature is reduced accordingly, thus permitting an increased current-carrying capacity at an equal winding temperature. The EMC performance of the drive system is further improved by the present invention.

According to one advantageous exemplary embodiment, it is provided that the at least one intermediate capacitor element assumes a smaller volume than each of the capacitor elements. An intermediate capacitor element thus configured can, to some extent, advantageously occupy the resulting interspaces between the capacitor elements, and thus advantageously increase the overall capacitance of the capacitor.

According to one advantageous exemplary embodiment, it is provided that the capacitor elements are in mutual contact. The capacitor elements, for example, are packed in a compact arrangement and engage in mutual contact at various points. For example, the capacitor elements can be stacked and/or arranged next to one another.

According to one advantageous exemplary embodiment, it is provided that the capacitor elements are configured in the form of foil capacitors, and particularly as flat windings. Foil capacitors comprise thin metal foils, which are separated by insulating foils the form of a dielectric material. The foils are wound, as a result of which high capacitance values are achieved in limited structural volumes. By the winding of foils, the foil capacitor assumes the form of a winding. Foils are thus wound cylindrically about a winding axis, such that a round cylindrical winding is produced. If the round winding is compressed, to some extent, in the radial direction, a “flat winding” is produced. A capacitor element which is described as a round winding assumes a circular cross section, perpendicularly to the winding axis about which the foils are wound. A capacitor element which is described as a flat winding assumes an oval-shaped cross section, or a cross section in the shape of a quadrilateral with rounded corners, perpendicularly to the winding axis about which the foils are wound.

According to an advantageous exemplary embodiment, it is provided that the intermediate capacitor element is configured in the form of a foil capacitor, particularly as a round winding. If the capacitor elements are configured as flat windings, and the latter are of an identical design and are tightly packed, an intermediate capacitor element which is configured in the form of a round winding can be adapted, in an advantageously simple manner, to an interspace between mutually adjoining capacitor elements, for example to an interspace between four capacitor elements.

According to an advantageous exemplary embodiment, it is provided that, between the plurality of capacitor elements, a plurality of interspaces are configured, wherein an intermediate capacitor element is arranged in each of the interspaces. Accordingly, all the interspaces between the capacitor elements are employed, thereby increasing the capacitance of the capacitor with an equal overall structural space for said capacitor.

According to an advantageous exemplary embodiment, it is provided that an interspace is arranged between four capacitor elements respectively, wherein an intermediate capacitor element is arranged between said four capacitor elements. If the capacitor elements, particularly capacitor elements of identical design, for example in the form of flat windings, are tightly packed, such that a plurality of rows, each comprised of a plurality of capacitor elements, are arranged one above another, thereby resulting in a compact packing of capacitor elements, one interspace is constituted respectively between each four capacitor elements, as a result of the non-cuboid shape of the capacitor elements, which are configured in the form of foil capacitors. If the capacitor elements are arranged in this manner, and the interspaces are occupied by intermediate capacitor elements, this results overall in a particularly compact packing of the capacitor elements and intermediate capacitor elements in the capacitor.

According to an advantageous exemplary embodiment, it is provided that the intermediate capacitor element engages in contact with each of the four capacitor elements in the interspace. It is thus ensured, firstly, that the interspace is occupied to the maximum possible extent and, secondly, that heat is distributed effectively and uniformly through the capacitor at the same time, by means of said contact.

According to an advantageous exemplary embodiment, it is provided that the capacitor elements, with respect to their longitudinal axes, are arranged in parallel with one another. The term “longitudinal axes” describes the axes along which the capacitor elements extend with a constant cross section. In the case of foil capacitors in the form of flat windings or round windings, the longitudinal axes are the winding axes about which the foils of the foil capacitor are wound. This results in a particularly dense packing of the capacitor elements, and thus a particularly high overall capacitance of the capacitor.

According to an advantageous exemplary embodiment, it is provided that the intermediate capacitor element, with respect to its longitudinal axis, is arranged parallel to the longitudinal axes of the capacitor elements. This results in a particularly dense packing of the capacitor elements and the intermediate capacitor elements, and thus a particularly high overall capacitance of the capacitor.

### BRIEF DESCRIPTION OF THE DRAWINGS

An exemplary embodiment of the invention is represented schematically in the drawing, and is described in greater detail in the following description. In the drawing:

FIG. 1 shows a schematic representation of parallel-connected capacitor elements in a capacitor;

FIG. 2 shows an exemplary embodiment of a capacitor according to the invention.

### DETAILED DESCRIPTION

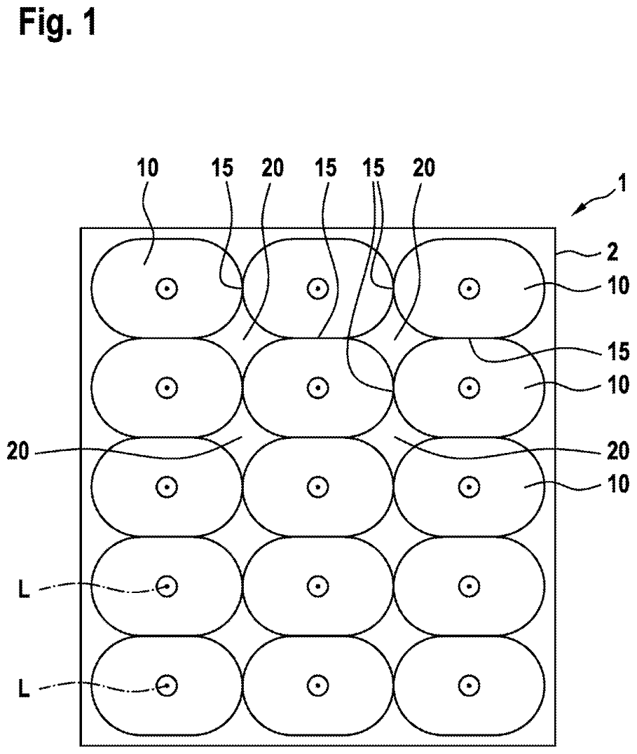

FIG. 1 shows a schematic representation of a capacitor, which is constituted of capacitor elements. The capacitor is an intermediate circuit capacitor for a multi-phase system. The intermediate circuit capacitor can be employed in drive system inverters.

In the context of the present application, a capacitor element 10 is understood as a structure which, in isolation, can constitute a capacitor. Various capacitor technologies such as, for example, stacked capacitors, round-wound capacitors or flat-wound capacitors can be employed as capacitor elements 10.

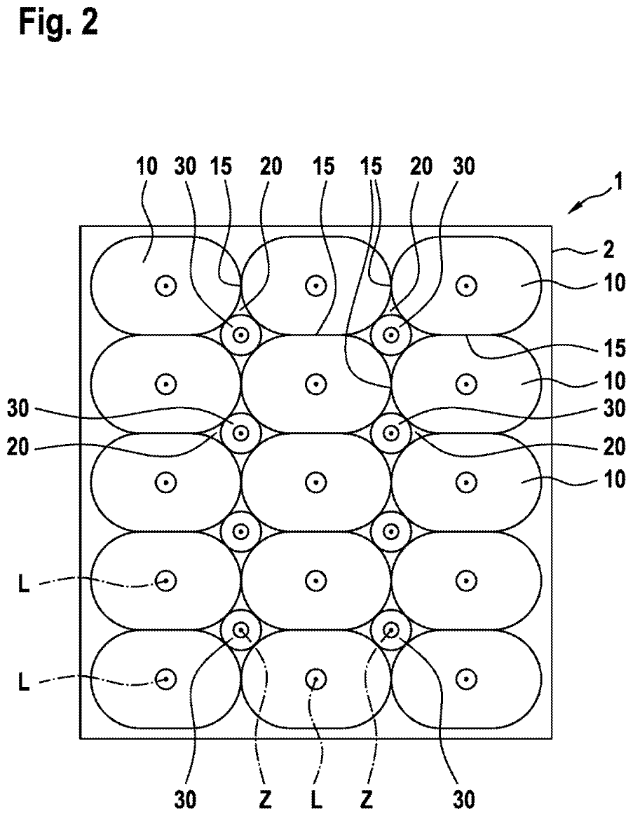

In the exemplary embodiments, the capacitor elements 10 are configured in the form of foil capacitors. Foil capacitors comprise thin metal foils, which are separated by insulating foils in the form of a dielectric material. The foils are wound, as a result of which high capacitance values are achieved in limited structural volumes. By the winding of foils, the foil capacitor assumes the form of a winding. Foils are thus wound cylindrically about a winding axis, such that a round cylindrical winding is produced. If the round winding is compressed, to some extent, in the radial direction, a “flat winding” is produced. A capacitor element which is described as a round winding assumes a circular cross section, perpendicularly to the winding axis about which the foils are wound. A capacitor element which is described as a flat winding assumes an oval-shaped cross section, or a cross section in the shape of a quadrilateral with rounded corners, perpendicularly to the winding axis about which the foils are wound. The capacitor elements 10 represented in the exemplary embodiments according to FIG. 1 and FIG. 2 are all configured to an identical design, in the form of flat windings.

As represented in FIG. 1, in a cross-sectional view of an intermediate circuit capacitor, the employment of flat windings as capacitor elements 10 results in the constitution of interspaces 20 in the capacitor 1. The interspaces 20 are not filled with a capacitive material, and are generally occupied by a casting compound. As can clearly be seen in FIG. 1, interspaces 20 between the capacitor elements 10 are produced by the rounded corners of the capacitor elements 10, which are configured in the form of flat windings, where said capacitor elements 10 are packed together to constitute a capacitor 1, wherein capacitor elements 10 are stacked to form rows.

The capacitor elements 10 are arranged such that their longitudinal axes L are oriented parallel to one another. In FIG. 1 and FIG. 2, the longitudinal axes L of the capacitor elements 10 are oriented perpendicularly to the drawing plane. The term “longitudinal axes” describes the axes along which the capacitor elements extend with a constant cross section. In the case of foil capacitors in the form of flat windings or round windings, the longitudinal axes L, Z are the winding axes about which the foils of the foil capacitor are wound. The capacitor elements 10 engage in contact at the contact points 15. Each interspace 15 is thus enclosed on four sides by four capacitor elements 10 respectively. In the exemplary embodiments in FIG. 1 and FIG. 2, for example, five rows comprised of three capacitor elements 10 respectively are arranged one above another.

The capacitor elements 10 which, in combination, constitute the capacitor 1, are all mutually connected in parallel, such that the capacitances of the individual capacitor elements 10 are added together. For the electrical contact-connection of the capacitor elements 10, in the present exemplary embodiment, the capacitor elements 10 are contact-connected at one end face, in an electrically conductive manner, to a first voltage level 2 and, at the second end faces of the capacitor elements 10 which are arranged opposite the first end faces of the capacitor elements 10, are contact-connected to a second voltage level. The capacitor elements 10 are thus arranged, for example, between the first voltage level 2 and the second voltage level. The capacitor 1 can be electrically contact-connected to the first voltage level 2 by means of electric terminals, and electrically contact-connected to the second voltage level by means of electric terminals. The capacitor elements 10 can be referred to as “main” capacitor elements to distinguish them from the “intermediate” capacitor elements described below.

FIG. 2 shows an exemplary embodiment of the capacitor 1 according to the invention. In the capacitor 1, intermediate capacitor elements 30 are arranged in the interspaces 20 between the capacitor elements 10. The intermediate capacitor elements 30 are connected in parallel with the capacitor elements 10 and thus, in combination with the capacitor elements 10, constitute the capacitor 1. However, the capacitor elements can also be serially connected, at least in part, i.e. in a series-connected arrangement. The capacitances of the intermediate capacitor elements 30 and the capacitances of the capacitor elements 10 are thus added together. The intermediate capacitor elements 30 are electrically contact-connected, for example, via the first voltage level 2 and the second voltage level, and are thus connected in parallel with the capacitor elements 10.

The intermediate capacitor elements 30, for example, are of an identical design, and one intermediate capacitor element 30 assumes a smaller volume than one capacitor element 10. Accordingly, one intermediate capacitor element 30 also assumes a lower capacitance than one capacitor element 10.

In this exemplary embodiment, the intermediate capacitor elements 30 are configured in the form of foil capacitors. The intermediate capacitor elements are preferably configured as round windings, as these can be inserted particularly effectively into the interspaces 20 between the capacitor elements 10.

If the capacitor 1 in the present exemplary embodiment is constituted of capacitor elements 10 in the form of flat windings, this produces interspaces 20 in which intermediate capacitor elements 30 of circular cross section can be particularly effectively inserted, and which occupy the interspace 20 in a particularly effective manner. Accordingly, a particularly high overall capacitance of the capacitor 1 can be achieved, with an equal structural space.

As represented in FIG. 2, one intermediate capacitor element 30 is arranged between four capacitor elements 10 respectively. The intermediate capacitor element 30 thus engages with each of the four capacitor elements 10 in the interspace 20 between said four capacitor elements 10. Direct contact can be constituted between the intermediate capacitor element 30 and the capacitor elements 10, wherein the intermediate capacitor element 30 lies in contact with the capacitor element 10. However, a narrow gap can also be constituted between the capacitor element 10 and the intermediate capacitor element 30, which is filled, for example, with a casting compound, thereby constituting the contact between the capacitor elements 10 and the intermediate capacitor element 30.

The intermediate capacitor elements 30 are preferably configured in the form of foil capacitors, and particularly as round windings. The intermediate capacitor elements 30 thus assume a cylindrical shape, with a circular cross section.

The intermediate capacitor elements 30 are arranged such that their longitudinal axes Z are oriented in parallel with the longitudinal axes L of the capacitor elements 10. In FIG. 1 and FIG. 2, the longitudinal axes Z of the intermediate capacitor elements 30 are oriented perpendicularly to the drawing plane. The term “longitudinal axes Z” describes the axes along which the capacitor elements extend with a constant cross section. In the case of foil capacitors in the form of flat windings or round windings, the longitudinal axes L, Z are the winding axes about which the foils of the foil capacitor are wound.

Naturally, further forms of embodiment and combined forms of the exemplary embodiments represented are also possible.

1. A capacitor (1) having a plurality of main capacitor elements (10) of identical design, which are mutually connected in parallel and/or in series and, in combination, constitute the capacitor (1), wherein at least one interspace (20) is constituted between the main capacitor elements (10),
characterized in that
at least one intermediate capacitor element (30) is arranged in the interspace (20), wherein the intermediate capacitor element (30) is connected in parallel with the main capacitor elements (10) and thus, in combination with the main capacitor elements (10), constitutes the capacitor (1).

2. The capacitor as claimed in claim 1, characterized in that the at least one intermediate capacitor element (30) assumes a smaller volume than each of the main capacitor elements (10).

3. The capacitor as claimed in claim 1, characterized in the main capacitor elements (10) are in mutual contact.

4. The capacitor as claimed in claim 1, characterized in that the main capacitor elements (10) are configured in the form of foil capacitors.

5. The capacitor as claimed in claim 1, characterized in that the intermediate capacitor element (30) is configured in the form of a foil capacitor.

6. The capacitor as claimed in claim 1, characterized in that, between the plurality of main capacitor elements (10), a plurality of interspaces (20) are constituted, wherein an intermediate capacitor element (30) is arranged in each of the interspaces (20).

7. The capacitor as claimed in claim 1, characterized in that an interspace (30) is constituted between four main capacitor elements (10) respectively, wherein an intermediate capacitor element (30) is arranged between said four main capacitor elements (10) in the interspace (20).

8. The capacitor as claimed in claim 7, characterized in that the intermediate capacitor element (30) engages with each of the four main capacitor elements (10) in the interspace (20).

9. The capacitor as claimed in claim 1, characterized in that the main capacitor elements (10) have respective longitudinal axes (L), and with respect to the longitudinal axes (L), are arranged in parallel with one another.

10. The capacitor as claimed in claim 9, characterized in that the intermediate capacitor element (30) has a longitudinal axes (Z), and with respect to the longitudinal axis (Z), is arranged in parallel with the longitudinal axes (L) of the main capacitor elements (10).

11. The capacitor as claimed in claim 1, wherein the capacitor (1) is an intermediate circuit capacitor for a multi-phase system.

12. The capacitor as claimed in claim 4, characterized in that the main capacitor elements (10) are configured in the form of flat windings.

13. The capacitor as claimed in claim 5, characterized in that the intermediate capacitor element (30) is configured in the form of a round winding.
